(19) United States
(12) Patent Application Publication
(10) Pub. No.: US 2023/0318098 A1
(43) Pub. Date: Oct. 5, 2023

(54) SECONDARY BATTERY

(71) Applicant: HONDA MOTOR CO., LTD., Tokyo (JP)

(72) Inventors: Hidemasa USUI, Saitama (JP); Takahiro TAMURA, Saitama (JP)

(21) Appl. No.: 18/190,989

(22) Filed: Mar. 28, 2023

(30) Foreign Application Priority Data
Mar. 31, 2022 (JP) 2022-057967

(51) Int. Cl. H01M 50/129; H01M 50/121; H01M 50/119; H01M 50/105; H01M 50/186

(52) U.S. Cl. CPC H01M 50/129; H01M 50/121; H01M 50/119; H01M 50/105; H01M 50/186

(57) ABSTRACT

To provide a secondary battery comprising an electrode laminate and an exterior packaging member, the electrode laminate being wrapped with the exterior packaging member, wherein the exterior packaging member comprises an exterior packaging area that wraps the electrode laminate, a heat-sealing area, and an intermediate area existing between the exterior packaging area and the heat-sealing area; in the exterior packaging area, a layer containing a first resin, a layer containing a second resin, a layer containing metal, and a layer containing a third resin are sequentially laminated from an electrode laminate side; in the heat-sealing area the layer containing metal and the layer containing the third resin are sequentially laminated on both sides of the layer containing the second resin; and in the intermediate area, a resin pool comprising the first resin is formed.

This application is based on and claims the benefit of priority from Japanese Patent Application No. 2022-057967, filed on 31 Mar. 2022, the content of which is incorporated herein by reference.

### BACKGROUND OF THE INVENTION

### Field of the Invention

The present invention relates to a secondary battery.

### Related Art

In recent years, research and development have been carried out on secondary batteries which contribute to energy efficiency in order to ensure that many people have access to affordable, reliable, sustainable and advanced energy.

Patent Document 1 discloses a power storage device including contents including a positive electrode, a separator, a negative electrode, an electrolytic solution, and a tab composed of a lead and a tab sealant, and an exterior packaging material in which at least a metal foil layer, an anti-corrosion treated layer, an adhesive resin layer and a sealant layer are sequentially laminated on one surface side of a base material layer. Here, regarding the exterior packaging material, sealant layers are bonded to each other and a heat-sealed part is formed at the end of its surrounding, and the contents are housed and sealed so that the tab is partially located outside. In the adhesive resin layer, an olefinic elastomer is dispersed, and a resin pool of the sealant layers is formed on the inner side of the heat-sealed part. Further, as the sealant layer, a polypropylene resin film is used.
Patent Document 1: Japanese Unexamined Patent Application, Publication No. 2015-228387

### SUMMARY OF THE INVENTION

However, the polypropylene resin film has a low melting point. Therefore, the temperature of the heat-sealing area may increase to cause softening, and thus it is desired to improve the heat resistance of the heat-sealing area of the exterior packaging member. It is also desired to improve the sealing properties of the heat-sealing area of the exterior packaging member.

It is an object of the present invention to provide a secondary battery capable of improving the heat resistance and sealing properties of the heat-sealing area of an exterior packaging member.

In accordance with one aspect of the present invention, there is provided a secondary battery including an electrode laminate and an exterior packaging material, the electrode laminate including a positive electrode and a negative electrode which are laminated via an electrolyte interposed therebetween, the electrode laminate being wrapped with an exterior packaging member. The exterior packaging member includes an exterior packaging area that wraps the electrode laminate, a heat-sealing area, and an intermediate area existing between the exterior packaging area and the heat-sealing area. In the exterior packaging area, a layer containing a first resin, a layer containing a second resin, a layer containing metal, and a layer containing a third resin are sequentially laminated from the electrode laminate side. In the heat-sealing area, the layer containing metal and the layer containing a third resin are sequentially laminated on both sides of the layer containing a second resin, and in the intermediate area, a resin pool containing a first resin is formed.

In accordance with another aspect of the present invention, there is provided a secondary battery including an electrode laminate in which a positive electrode and a negative electrode are laminated via an electrolyte interposed therebetween and the electrode laminate is wrapped with an exterior packaging member. The exterior packaging member includes an exterior packaging area that wraps the electrode laminate, a heat-sealing area and an intermediate area existing between the exterior packaging area and the heat-sealing area. In the exterior packaging area, a layer containing a first resin or a layer containing a second resin, a layer containing metal, and a layer containing a third resin are sequentially laminated from an electrode laminate side. In the heat-sealing area, the layer containing metal and the layer containing a third resin are sequentially laminated on both sides of the layer containing a second resin, and in the intermediate area, a resin pool containing the first resin is formed.

The secondary battery may be a solid battery.

In the electrode laminate, the positive electrode and the negative electrode may be laminated via a solid electrolyte layer interposed therebetween.

In accordance with another aspect of the present invention, there is provided a method for producing a secondary battery, the method including wrapping both sides of an electrode laminate with a laminate film, the electrode laminate including a positive electrode and a negative electrode which are laminated via an electrolyte interposed therebetween, the laminate film including a layer containing a first resin, a layer containing a second resin, a layer containing metal, and a layer containing a third resin which are sequentially laminated from the electrode laminate side, and heat-sealing the laminate film that wraps both sides of the electrode laminate, wherein when heat-sealing, the first resin being allowed to flow to the electrode laminate side to form a resin pool containing the first resin.

According to the present invention, it is possible to provide a secondary battery capable of improving the heat resistance and sealing properties of the heat-sealing area of an exterior packaging member.

### BRIEF DESCRIPTION OF THE DRAWINGS

FIG. 1 is a cross-sectional view showing an example of a secondary battery of the present embodiment;

FIGS. 2A and 2B are cross-sectional views showing a laminate structure in the exterior packaging area and the heat-sealing area in FIG. 1;

FIG. 3 is a cross-sectional view for explaining an example of a method for producing a secondary battery of FIG. 1; and

FIG. 4 is a cross-sectional view for explaining another example of a method for producing a secondary battery of FIG. 1.

### DETAILED DESCRIPTION OF THE INVENTION

Embodiments of the present invention will be described below with reference to the drawings.

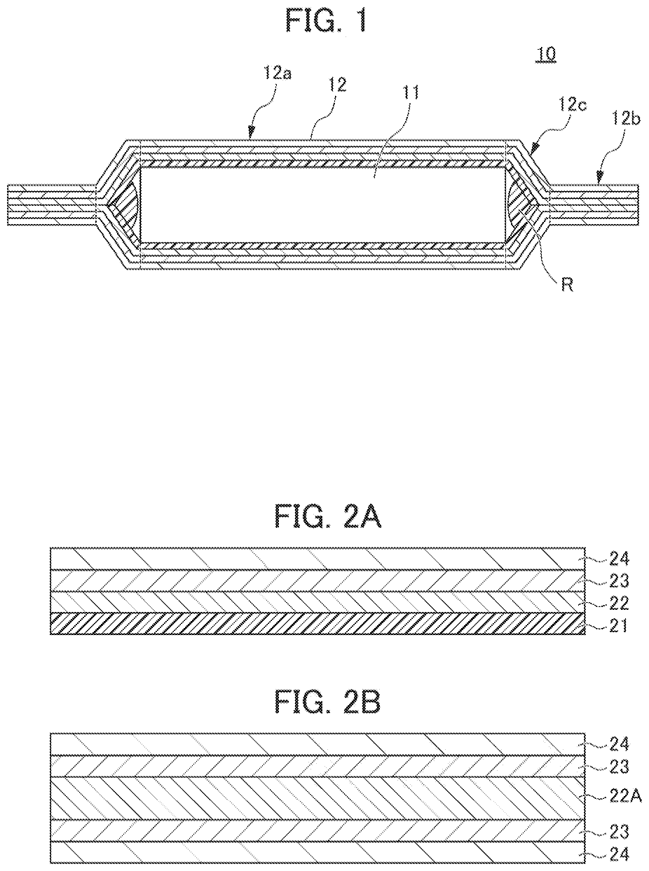

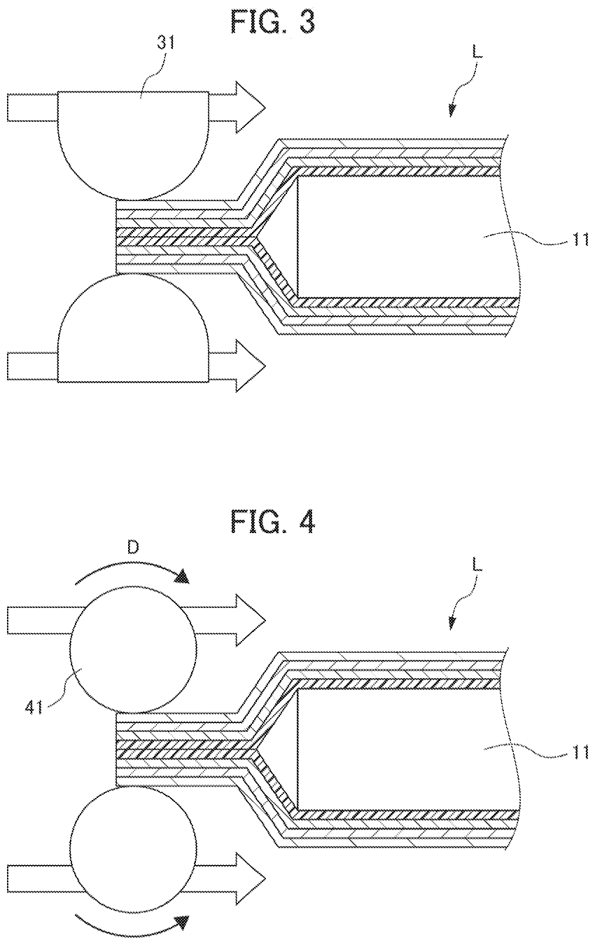

FIG. 1 shows an example of a secondary battery of the present embodiment.

Regarding a secondary battery 10, an electrode laminate 11, in which a positive electrode and a negative electrode are laminated via an electrolyte interposed therebetween, is wrapped with an exterior packaging member 12. The exterior packaging member 12 includes an exterior packaging area 12a that wraps the electrode laminate 11, a heat-sealing area 12b, and an intermediate area 12c existing between the exterior packaging area 12a and the heat-sealing area 12b. Here, regarding the exterior packaging area 12a, a layer 21 containing a first resin, a layer 22 containing a second resin, a layer 23 containing metal and a layer 24 containing a third resin are sequentially laminated, from the side of the electrode laminate 11 (see FIG. 2A). Regarding the heat-sealing area 12b, the layer 23 containing metal and the layer 24 containing a third resin are sequentially laminated on both sides of the layer 22A containing a second resin (see FIG. 2B). Therefore, the heat resistance of the heat-sealing area 12b is improved. In the intermediate area 12c, a resin pool R containing a first resin is formed. Therefore, sealing properties of the heat-sealing area 12b are improved.

The first resin is not particularly limited as long as it is a thermoplastic resin which flows to the side of the electrode laminate 11 during heat-sealing mentioned below, and examples thereof include polypropylene (melting point of 160° C.), low density polyethylene (melting point of 95 to 130° C.), high density polyethylene (melting point of 120 to 140° C.), polystyrene (melting point of 100° C.), AS resin (melting point of 115° C.), polyvinyl chloride (melting point of 85 to 200° C.), ABS resin (melting point of 100 to 125° C.) and the like.

The melting point of the first resin is not particularly limited and is, for example, 120° C. or higher and 170° C. or lower.

The thickness of the layer 21 containing a first resin is not particularly limited and is, for example, 35 μm or more and 320 μm or less.

The second resin is not particularly limited as long as it is a thermoplastic resin which does not flow to the side of the electrode laminate 11 during heat-sealing mentioned below, and examples thereof include polyethylene terephthalate (PET, melting point of 260° C.), polyvinyl chloride (melting point of 85 to 200° C.), polyvinyl alcohol (melting point of 200° C.), polyvinylidene chloride (melting point of 210° C.), polyamide (melting point of 170 to 265° C.), polybutylene terephthalate (melting point of 230 to 270° C.), polyphenylene sulfide (melting point of 290° C.) and the like.

The melting point of the second resin is not particularly limited and is, for example, 170° C. or higher and 290° C. or lower.

The thickness of the layer 22 containing a second resin is not particularly limited and is, for example, 12 μm or more and 80 μm or less. The thickness of the layer 22A containing a second resin is not particularly limited and is, for example, 24 μm or more and 160 μm or less.

In the exterior packaging area 12a, the layer 21 containing a first resin or the layer 22 containing a second resin may be formed or not. Thereby, the energy density of the secondary battery 10 is improved.

Examples of the metal include, but are not particularly limited to, aluminum and the like.

The thickness of the layer 23 containing metal is not particularly limited and is, for example, 40 μm or more and 80 μm or less.

The third resin is not particularly limited as long as the layer 24 containing a third resin is not melted and lost during heat-sealing mentioned below, and examples thereof include polyethylene terephthalate, polyvinyl chloride, polyvinyl alcohol, polyvinylidene chloride, polyamide, polybutylene terephthalate, polyphenylene sulfide and the like.

The melting point of the third resin is preferably the same as or higher than the melting point of the second resin.

The thickness of the layer 24 containing a third resin is not particularly limited and is, for example, 15 μm or more and 25 μm or less.

The electrode laminate is in the form of a sheet, and an electrode mixture layer is formed on an electrode current collector in each electrode. Namely, in the positive electrode, a positive electrode mixture layer is formed on a positive electrode current collector, and in the negative electrode, a negative electrode mixture layer is formed on a negative electrode current collector. In addition, the electrolyte is not particularly limited and is, for example, contained in an electrolytic solution with which a common resin porous film (separator) is impregnated. When the secondary battery 10 is a solid battery, the electrolyte is contained in a gel electrolyte layer, a solid electrolyte layer and the like.

Regarding the electrode laminate, a positive electrode and a negative electrode may be laminated via an electrolyte interposed therebetween, and the electrode laminate may include a plurality of positive electrodes and/or negative electrodes. Examples of the laminate structure of the electrode laminate including a plurality of positive electrodes and/or negative electrodes include positive electrode/electrolyte/negative electrode/electrolyte/positive electrode and the like. At this time, the electrode laminate can be produced, for example, by roll pressing.

The method for producing a secondary battery 10 includes wrapping both sides of an electrode laminate 11 with a laminate film L in which a layer 21 containing a first resin, a layer 22 containing a second resin, a layer 23 containing a metal and a layer 24 containing a third resin (see FIG. 2A) are sequentially laminated from the side of the electrode laminate 11, and heat-sealing the laminate film L that wraps both surfaces of the electrode laminate 11. Here, in the case of heat-sealing the laminate film L, by moving a heat-sealing bar 31 toward the electrode laminate 11, the first resin is allowed to flow to the side of the electrode laminate 11 to form a resin pool R containing a first resin.

It should be noted that the heat-sealing conditions such as temperature and moving speed of the heat-sealing bar 31 can be appropriately set according to the melting point of the first resin, the melting point of the second resin and the like.

Using a heat-sealing roll 41 in place of the heat-sealing bar 31, the heat-sealing roll 41 may be moved toward the electrode laminate 11 while rotating in the direction D in which the first resin flows to the side of the electrode laminate 11 (see FIG. 4). Thereby, friction of the laminate film L is suppressed.

Hereinafter, a description will be made of the case where the secondary battery of the present embodiment is an all-solid lithium secondary battery.

Examples of the positive electrode current collector include, but are not particularly limited to, an aluminum foil and the like.

The positive electrode mixture layer contains a positive electrode active material, and may further contain a solid electrolyte, a conductive aid, a binder and the like.

The positive electrode active material is not particularly limited as long as it is capable of storing and releasing lithium ions, and examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur and the like.

The solid electrolyte constituting the solid electrolyte layer is not particularly limited as long as it is capable of conducting lithium ions, and examples thereof include an oxide-based electrolyte, a sulfide-based electrolyte and the like.

The negative electrode mixture layer contains a negative electrode active material, and may further contain a solid electrolyte, a conductive aid, a binder and the like.

The negative electrode active material is not particularly limited as long as it is capable of storing and releasing lithium ions, and examples thereof include metal lithium, lithium alloy, metal oxide, metal sulfide, metal nitride, Si, SiO, carbon material and the like. Examples of the carbon material include artificial graphite, natural graphite, hard carbon, soft carbon and the like.

Examples of the negative electrode current collector include, but are not particularly limited to, a copper foil and the like.

While embodiments of the present invention have been described, the present invention is not limited to the above embodiments and the above embodiments may be appropriately varied within the spirit of the present invention.

### EXPLANATION OF REFERENCE NUMERALS

10 Secondary battery
11 Electrode laminate
12 Exterior packaging member
12a Exterior packaging area
12b Heat-sealing area
12c Intermediate area
21 Layer containing first resin
22, 22A Layer containing second resin
23 Layer containing metal
24 Layer containing third resin
31 Heat-sealing bar
41 Heat-sealing roll
L Laminate film
R Resin pool containing first resin

What is claimed is:

1. A secondary battery comprising an electrode laminate and an exterior packaging member, the electrode laminate comprising a positive electrode and a negative electrode which are laminated via an electrolyte interposed therebetween, the electrode laminate being wrapped with the exterior packaging member,
wherein the exterior packaging member comprises an exterior packaging area that wraps the electrode laminate, a heat-sealing area, and an intermediate area existing between the exterior packaging area and the heat-sealing area,
in the exterior packaging area, a layer containing a first resin, a layer containing a second resin, a layer containing metal, and a layer containing a third resin are sequentially laminated from an electrode laminate side,
in the heat-sealing area the layer containing metal and the layer containing the third resin are sequentially laminated on both sides of the layer containing the second resin, and
in the intermediate area, a resin pool comprising the first resin is formed.

2. A secondary battery comprising an electrode laminate and an exterior packaging member, the electrode laminate comprising a positive electrode and a negative electrode which are laminated via an electrolyte interposed therebetween, the electrode laminate being wrapped with the exterior packaging member,
wherein the exterior packaging member comprises an exterior packaging area that wraps the electrode laminate, a heat-sealing area, and an intermediate area existing between the exterior packaging area and the heat-sealing area,
in the exterior packaging area, a layer containing a first resin or a layer containing a second resin, a layer containing metal, and a layer containing a third resin are sequentially laminated from an electrode laminate side,
in the heat-sealing area, the layer containing metal and the layer containing the third resin are sequentially laminated on both sides of the layer containing the second resin, and
in the intermediate area, a resin pool containing the first resin is formed.

3. The secondary battery according to claim 1, is the secondary battery being a solid battery.

4. The secondary battery according to claim 3, wherein, in the electrode laminate, the positive electrode and the negative electrode are laminated via a solid electrolyte layer interposed therebetween.

5. A method for producing a secondary battery, comprising wrapping both sides of an electrode laminate with an exterior packaging material, the electrode laminate comprising a positive electrode and a negative electrode which are laminated via an electrolyte interposed therebetween, the laminate film comprising a layer containing a first resin, a layer containing a second resin, a layer containing metal, and a layer containing a third resin which are sequentially laminated from an electrode laminate side, and
heat-sealing the laminate film that wraps both sides of the electrode laminate,
wherein when heat-sealing, the first resin is allowed to flow to an electrode laminate side to form a resin pool containing a first resin.
